(19) United States
(12) Patent Application Publication
(10) Pub. No.: US 2007/0002891 A1
(43) Pub. Date: Jan. 4, 2007

(54) In-vehicle wireless device

(75) Inventor: Koji Shinoda, Chiryu-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/475,591

(22) Filed: Jun. 27, 2006

(30) Foreign Application Priority Data
Jun. 29, 2005 (JP) 2005-189895

(51) Int. Cl. H04L 12/66

(52) U.S. Cl. 370/463

(57) ABSTRACT

A wireless device in a vehicle interfaces with an associated device having a user interface. A wireless circuit included in the wireless device establishes a communications link with a wireless network while the associated device functioning as an end terminal communicates with the network via the communications link. When the interface between the wireless device and associated device is disrupted, the wireless device intentionally disconnects the communications link with the wireless network.

### CROSS REFERENCE TO RELATED APPLICATIONS

This application is based on and incorporates herein by reference Japanese Patent Application No. 2005-189895 filed on Jun. 29, 2005.

### FIELD OF THE INVENTION

The present invention relates to an in-vehicle wireless communications device (or in-vehicle wireless device), through which an associated device as an end terminal is allowed to communicate with a wireless network.

### BACKGROUND OF THE INVENTION

Japanese Patent Application No. 2005-077192 (U.S. patent application Ser. No. 11/376,685) discloses a wireless device having interface circuits, which interface with a vehicular device and an associated device (or subordinate device such as a navigation device), respectively. The interface circuit with the vehicular device receives a security detection signal from a security sensor or an emergency detection signal (such as help detection signal from a help switch or air-bag detection signal from an air-bag ECU). Upon receiving the detection signal, the wireless device communicates with a wireless network while functioning as a communications end terminal (hereinafter called only “end terminal”). In contrast, upon receiving a transmission command from the associated device, the wireless device allows the associated device to communicate with the wireless network while the associated device functions as an end terminal.

The wireless device may have no user interface for a user to operate, while the associated device may has a user interface. An interface between the wireless device and associated device may be disrupted while a communications link is established between the wireless device and the wireless network. In this case, the user cannot disconnect the communications link with the wireless network. This may involve unnecessary charges due to unintended communications, and may occupy communications channels to consume network resources.

### SUMMARY OF THE INVENTION

It is an object of the present invention to provide a wireless device capable of preventing communications charge unintended for a user and channel occupation useless for a network.

According to an aspect of the present invention, an in-vehicle wireless device is provided with the following. Through the in-vehicle wireless device, an associated device is allowed to communicate with a wireless network. The in-vehicle wireless device includes (i) a wireless circuit that establishes and disconnects a communications link with the wireless network; (ii) an interface circuit that interfaces with the associated device; and (iii) a control circuit that executes a determination of whether an interface is disrupted between the interface circuit and the associated device while the associated device functions as an end terminal for communications with the network via a communications link established between the wireless circuit and the wireless network. When the determination is affirmative, the control circuit causes the wireless circuit to disconnect the established communications link.

### BRIEF DESCRIPTION OF THE DRAWINGS

The above and other objects, features, and advantages of the present invention will become more apparent from the following detailed description made with reference to the accompanying drawings. In the drawings:

FIG. 1 is a functional diagram illustrating an overall structure of an example according to a first embodiment of the present invention;

FIG. 2 is a flow chart diagram illustrating a process of a wireless device in FIG. 1; and

FIG. 3 is a flow chart diagram illustrating a process of a wireless device included in an example according to a second embodiment.

### DETAILED DESCRIPTION OF THE PREFERRED EMBODIMENTS

### First Embodiment

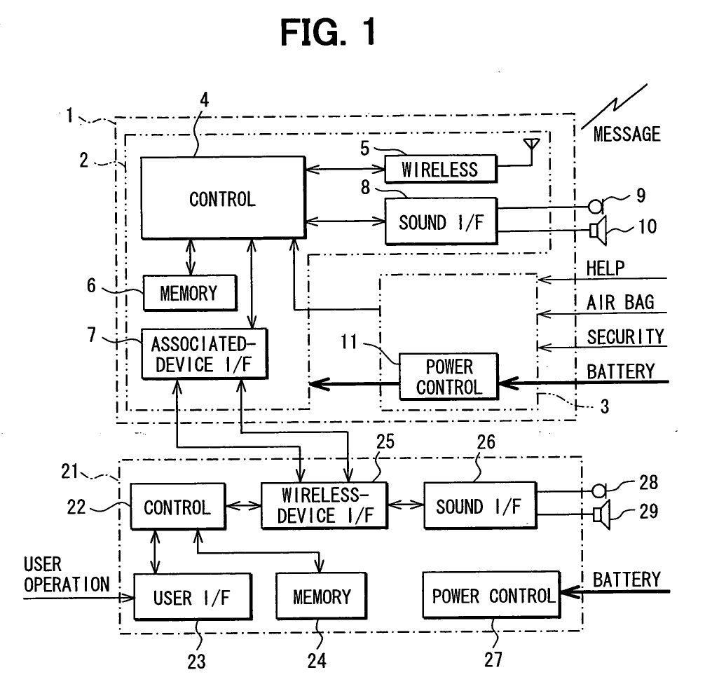

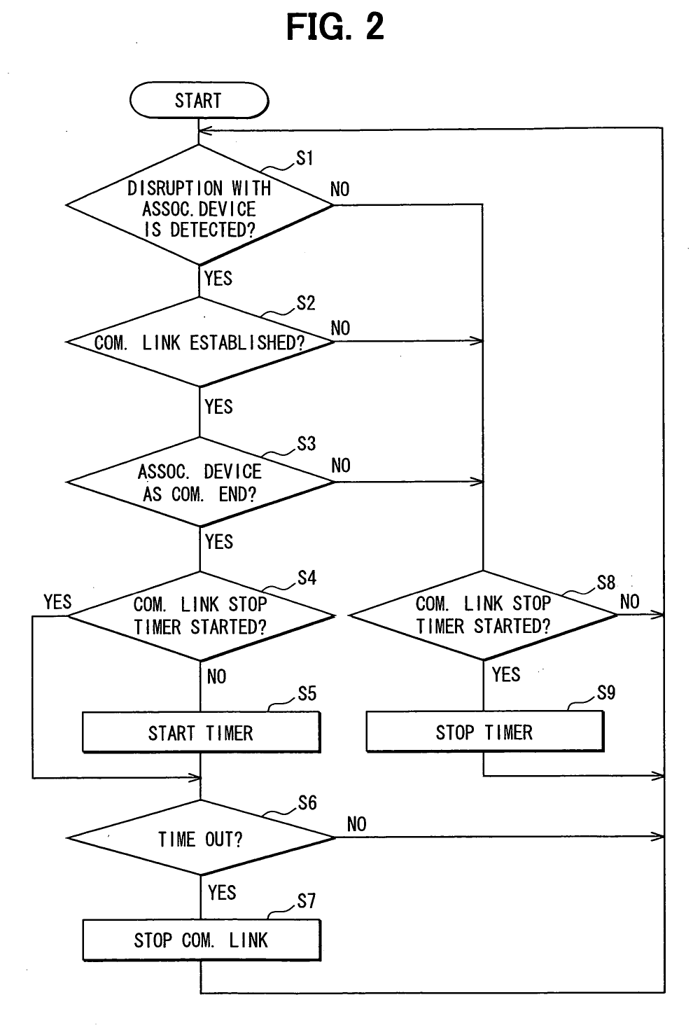

An in-vehicle wireless device as an example according to a first embodiment of the present invention will be explained with reference to FIGS. 1 and 2.

As shown in FIG. 1, the in-vehicle wireless device 1 provided in a vehicle includes a wireless module 2 and a vehicular interface circuit 3. The module 2 includes a control circuit 4, wireless circuit 5, a memory circuit 6, associated-device interface circuit 7 interfacing with an associated device 21, and sound interface circuit 8.

The control circuit 4 executes control programs to control overall operations of the wireless module 2. The wireless circuit 5 establishes and disconnects a communications link (or communications line) with a wireless communications network (or wireless network) based on instructions by the control circuit 4. The memory circuit 6 stores a variety of information necessary for the control circuit 4 to execute the control programs.

The sound interface circuit 8 connects with a microphone 9 and a speaker 10 to process transmission sounds inputted via the microphone 9 and reception sounds to be outputted via the speaker 10, respectively. For instance, a user can talk with an operator in a service center through a communications link established after the device 1 sends an emergency report signal to the service center. Furthermore, the user can vocally ask a rescue from the center or vocally report an accident.

The vehicular interface circuit 3 receives the following: a help detection signal from a help switch, an air-bag detection signal from an air-bag ECU, or a security detection signal from a security sensor. The help detection signal indicates that a user operates the help switch. The air-bag detection signal indicates that an air-bag is expanded. The security detection signal indicates that an abnormality (e.g., theft) has arisen in the vehicle. Upon receiving the above signal, the vehicular interface circuit 3 reports corresponding information to the control circuit 4. Upon receiving the corresponding information, the control circuit 4 detects respective detections and sends an emergency report signal (e.g., a help report signal or air-bag report signal), or security report signal to the service center via the wireless circuit 5.

The vehicular interface circuit 3 includes a power control circuit 11 to connect with an in-vehicle battery to supply the wireless module 2 with operation power. The control circuit 4, wireless circuit 5, memory circuit 6, associated-device interface circuit 7, and sound interface circuit 8 operate on the power via the power control circuit 11.

The associated device 21 can be a navigation system to include a control circuit 22, a user interface circuit 23, memory circuit 24, wireless-device interface circuit 25, sound interface circuit 26, and power control circuit 27. The control circuit 22 executes control programs to control overall operations of the associated device 21. The user interface circuit 23 includes mechanical buttons or touch panel on a display device to receive user operation or instruction. The memory circuit 24 stores a variety of information necessary for the control circuit 22 to execute control programs. The wireless-device interface circuit 25 interfaces with the in-vehicle wireless device 1. An interface between the in-vehicle wireless device 1 and associated device 21 can be a USB (Universal Serial Bus) interface.

The sound interface circuit 26 connects with a microphone 28 and a speaker 29 to process transmission sounds inputted via the microphone 28 and reception sounds to be outputted via the speaker 29, respectively. The power control circuit 27 connects with the in-vehicle battery to supply operation power to the control circuit 22, user interface circuit 23, memory circuit 24, wireless-device interface circuit 25, and sound interface circuit 26.

In the above structural arrangement, each of the wireless device 1 and associated device 21 can communicate (e.g., execute an audio communications or data communications) with a wireless network as a communications end terminal (or an end terminal). For instance, in an audio communications, the wireless device 1 functions as an end terminal as follows: the control circuit 4 in the wireless device 1 sends transmission sounds inputted via the microphone 9 to the wireless network via the wireless circuit 5; the control circuit 4 receives reception sounds from the wireless network via the wireless circuit 5 and outputs them via the speaker 10. In contrast, the associated device 21 functions as an end terminal as follows: the control circuit 4 in the wireless device 1 sends transmission sounds inputted via the microphone 28 in the associated device 21 to the wireless network via the wireless circuit 5; the control circuit 4 receives reception sounds from the wireless network via the wireless circuit 5 and outputs them via the speaker 29 in the associated device 21. When the associated device 21 functions as the end terminal for communications with the wireless network, the interface between the associated-device interface circuit 7 and wireless-device interface circuit 25 is used.

The battery power is supplied from the battery to the wireless device 1 and associated device 21 via respective connection lines. This is because two devices 1 and 21 operate under respective operation conditions. The wireless device 1 needs to operate even when an accessory (ACC) switch of the vehicle is turned off; the associated device 21 can be activated by a user via the user interface circuit 23. For instance, the wireless device 1 needs to send a security report signal to the service center based on a security detection signal from the security sensor, even when the ACC switch is turned off. In contrast, the associated device 21 basically needs to operate only when a user is present in the vehicle and need not operate when the ACC switch is turned off. For instance, the communications link between the wireless circuit 5 and the wireless network can be disconnected based on a user instruction, which is accepted by the user interface circuit 23 and sent to the wireless circuit 5 via the interface circuits 25, 7 and control circuit 4.

Unlike the associated device 21, the wireless device 1 has no user interface. The wireless device 1 is designed to send an emergency report signal or security report signal by itself even if the associated device 21 is not coupled with the wireless device 1. For instance, a vehicle collision may damage the associated device 21 (e.g., navigation system) to disable the user interface of the associated device 21. The wireless device 1 is still able to automatically send, by itself, a help report signal, air-bag report signal, or security report signal to the service center by detecting the corresponding detection signal.

Next, an operation in the above structural arrangement will be explained with reference to a flow chart in FIG. 2. The control circuit 4 in the wireless device 1 executes this flow chart.

The control circuit 4 determines whether an interface between the associated-device interface circuit 7 and associated device 21 is disrupted (Step S1) by determining whether a voltage level of a control signal inputted via the interface circuit 7 from the device 21. “Being disrupted” includes physical breaking or unplugging of a connection cable or shut down of power supply to the associated device 21.

When the interface is determined to be disrupted (Step S1: YES), the control circuit 4 determines whether a communications link is established between the wireless circuit 5 and wireless network (Step S2). (The communications link includes a wireless link between the wireless circuit 5 and wireless network.) When the communications link is determined to be established (Step S2: YES), the control circuit 4 determines whether the associated device 21 is an end terminal for communications with the wireless network (Step S3).

When the associated device 21 is determined to function as an end terminal (Step S3: YES), the control circuit 4 determines whether a communications link stop timer is started (Step S4). This communications link stop timer can be included in the control circuit 4, e.g., when the control circuit 4 is provided as a microcomputer. When the communications link stop timer is determined to be not started (Step S4: NO), the control circuit 4 starts the communications link stop timer to count time (Step S5). The control circuit 4 then determines whether the communications link stop timer times out (Step S6). When the communications link stop timer is determined to time out (Step S6: YES), the control circuit 4 disconnects the communications link established between the wireless circuit 5 and wireless network (Step S7). In this example, the communications link stop timer times out in several seconds.

In contrast, when any one of the determinations at Steps S1, S2, and S3 is negative, the control circuit 4 determines whether the communications link stop timer is started (Step S8). When the communications link stop timer is determined to be started (Step S8: YES), the control circuit 4 stops the communications link stop timer (Step S9). The sequence then returns to Step S1.

In the above example of the first embodiment, the communications link is established between the wireless circuit 5 and wireless network, while the associated device 21 functions as an end terminal for communications with the wireless network via the established communications link. When the interface between the associated-device interface circuit 7 and associated device 21 is then determined to be disrupted, the in-vehicle wireless device 1 intentionally disconnects the communications link established between the wireless circuit 5 and wireless network. This can prevent communications charge unintended for a user, and channel occupation useless for the network.

Furthermore, a communications link stop timer is included to stop the established communications link when duration of interface disruption reaches a given time. This helps prevent unnecessary or excessive link disconnection due to temporary disruption (e.g., from unstable radio wave environment).

### Second Embodiment

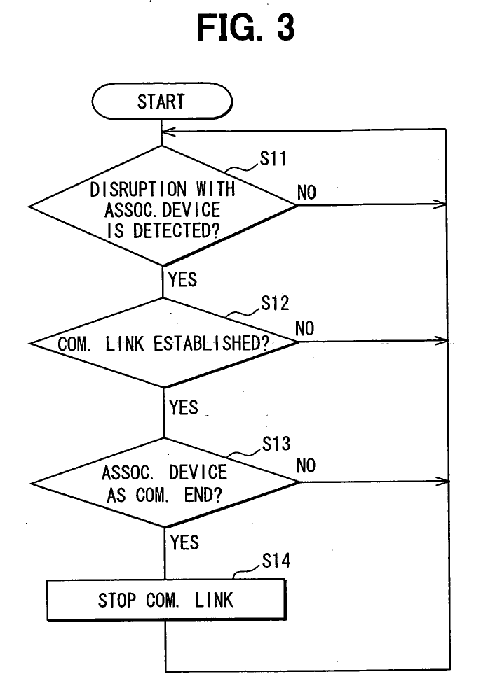

An example of a second embodiment will be explained with reference to a flow chart in FIG. 3. In this example, unlike the example of the first embodiment, a communications link stop timer is not included. Therefore, the wireless device 1 disconnects the established communications link with the wireless network without considering duration of interface disruption.

The control circuit 4 determines whether an interface between the associated-device interface circuit 7 and associated device 21 is disrupted (Step S11). When the interface is determined to be disrupted (Step S11: YES), the control circuit 4 determines whether a communications link is established between the wireless circuit 5 and wireless network (Step S12). When the communications link is determined to be established (Step S12: YES), the control circuit 4 determines whether the associated device 21 is a communications end terminal (Step S13). When the associated device 21 is determined to function as an end terminal (Step S13: YES), the control circuit 4 disconnects the communications link established between the wireless circuit 5 and wireless network without starting the communications link stop timer provided in the example of the first embodiment (Step S14).

The above explained example of the second embodiment can provide the same effect as that of the example of the first embodiment. The example can have an advantage in simplifying the process by the control circuit 4 in good radio wave environment, which might not cause temporary interface disruption.

### MODIFICATIONS

The in-vehicle wireless device 1 can also send an emergency report signal by receiving detection signals from other in-vehicle sensors via the vehicular interface circuit 11.

The associated device 21 can be replaced with any in-vehicle system other than the navigation system. The interface between the in-vehicle wireless device 1 and associated device 21 can be one of any types of interfaces complying with other standards, instead of the USB interface.

Each or any combination of processes or steps explained in the above can be achieved as a software unit (e.g., subroutine) and/or a hardware unit (e.g., circuit or integrated circuit), including or not including a function of a related device; furthermore, the hardware unit can be constructed inside of a microcomputer.

It will be obvious to those skilled in the art that various changes may be made in the above-described embodiments of the present invention. However, the scope of the present invention should be determined by the following claims.

What is claimed is:

1. An in-vehicle wireless device, through which an associated device is allowed to communicate with a wireless network,
the in-vehicle wireless device comprising:
a wireless circuit that establishes and disconnects a communications link with the wireless network;
an interface circuit that interfaces with the associated device; and
a control circuit that executes a determination of whether an interface is disrupted between the interface circuit and the associated device while the associated device functions as an end terminal for communications with the wireless network via a communications link established between the wireless circuit and the wireless network,
wherein, when the determination is affirmative, the control circuit causes the wireless circuit to disconnect the established communications link.

2. The in-vehicle wireless device of claim 1,
wherein, when the determination is affirmative, the control circuit causes the wireless circuit to disconnect the established communications link after duration of disruption of the interface reaches a predetermined time.

3. The in-vehicle wireless device of claim 1,
wherein no wireless function to establish and disconnect a communications link with the wireless network without using the wireless circuit is included in the associated device.

4. The in-vehicle wireless device of claim 1, wherein
the communications with the wireless network includes at least one of an audio communications and a data communications.

5. The in-vehicle wireless device of claim 1,
wherein no user interface for accepting a user instruction to disconnect the established communications link is comprised.

6. The in-vehicle wireless device of claim 1,
wherein the communications link between the wireless circuit and the wireless network is disconnected based on a user instruction, which is accepted by a user interface included in the associated device and sent to the wireless circuit via the interface circuit and the control circuit.

7. An in-vehicle wireless device, through which an associated device is allowed to communicate with a wireless network,
the in-vehicle wireless device comprising:
wireless means for establishing and disconnecting a communications link with the wireless network;
interfacing means for interfacing with the associated device; and
determining means for executing a determination of whether an interface is disrupted between the interfacing means and the associated device while the associated device functions as an end terminal for communications with the wireless network via a communications link established between the wireless means and the wireless network; and
controlling means for causing the wireless means to disconnect the established communications link when the executed determination is affirmative.

8. A method used in an in-vehicle wireless device, through which an associated device is allowed to communicate with a wireless network,
the in-vehicle wireless device including:
a wireless circuit that establishes and disconnects a communications link with the wireless network; and
an interface circuit that interfaces with the associated device,
the method comprising:
executing a determination of whether an interface is disrupted between the interface circuit and the associated device while the associated device functions as an end terminal for communications with the wireless network via a communications link established between the wireless circuit and the wireless network; and
causing the wireless circuit to disconnect the established communications link when the executed determination is affirmative.
